(19) United States
(12) Patent Application Publication
(10) Pub. No.: US 2026/0175818 A1
(43) Pub. Date: Jun. 25, 2026

(54) WIPER STRIP AND WIPER BLADE CONTAINING SAID WIPER STRIP

(71) Applicant: Robert Bosch GmbH, Stuttgart (DE)

(72) Inventors: Bence Szabo, Szakoly (HU); Christian Wilms, Beringen-Koersel (BE); Harun Erismis, Tervuren (BE); Nicolaas Gotzen, Kortenberg (BE); Wim Buseyne, Hasselt (BE)

(21) Appl. No.: 19/126,317

(22) PCT Filed: Oct. 27, 2023
(86) PCT No.: PCT/EP2023/080074

§ 371 Date: May 1, 2025

(30) Foreign Application Priority Data
Nov. 9, 2022 (DE) 10 2022 211 824.3

(51) Int. Cl. B60S 1/38

(52) U.S. Cl. CPC B60S 1/3881; B60S 1/38; B60S 1/3801; B60S 1/381; B60S 1/3863; B60S 1/3879; B60S 2001/3818

(57) ABSTRACT

The invention relates to a wiper strip comprising a wiper wedge (22) on which a wiper lip (24) is formed, and comprising a head part (28) which is connected by a tilt bar (26) to the wiper wedge (22) and which has a longitudinal groove (30) on each of two opposite sides of the head part (28) for engagement of a spring rail (42) into the head part (28) of the wiper strip (20), wherein the head part (28) furthermore has at least one damping element (32, 32b), a free end of which tapers the cross section of one of the longitudinal grooves (30).

### BACKGROUND

The present invention relates to a wiper strip, a wiper blade containing said wiper strip, and to the use thereof.

Wiper blades for motor vehicles usually have metal spring rails that engage in a rubber body, which is used to clean a windshield of the motor vehicle, for example. The spring rail is used to exert a corresponding contact pressure on the rubber body of the wiper blade, thus ensuring that the wiper blade cleans the windshield. At the end of each wiping movement of the wiper blade, the rubber body of the wiper blade flips over at a reversal point of the wiper blade.

At this moment of the reversal point, there may be a physical loss of contact between parts of the rubber body and the metal spring rail. As soon as a new wiping movement in the opposite direction begins, physical contact between the rubber body and the spring rail is restored. However, the temporary loss of contact between the rubber body and the spring rail can cause unpleasant flapping noises when the wiper blade turns between two wiping movements. Such a noise is undesirable.

In this regard, DE 10 2008 042 004 A1 discloses a wiper strip for a wiper blade, in which the rubber body of the wiper strip has a head strip in contact with a spring rail and a support section in contact with support section in contact with a wiper lip facing a glass surface, wherein the support section and the opposing head section of the wiper strip are designed so that when the wiper lip is turned over, the support section rolls along the head section.

Furthermore, DE 10 2019 205 931 A1 discloses a further wiper strip, in which a damping element is located between a support section surrounding the wiper lip and a head section of the wiper strip, which defines a stop surface at the reversal point of the wiper strip during operation, at which the damping element and the head part of the wiper strip touch at the moment the wiper strip is folded over.

### SUMMARY

A wiper strip, a wiper blade containing said wiper strip and its use are provided according to the invention.

A wiper strip in the form of a rubber body is provided, which comprises a wiper wedge on which a wiper lip for cleaning a surface is formed, and a head part which is connected to the wiper wedge via a tilt bar and which has on opposite sides of the head part in each case a longitudinal groove with respect to the longitudinal extension of the wiper strip, which enables the engagement of a particularly metallic spring rail in the longitudinal grooves of the head strip. The head part of the wiper strip also comprises at least one damping element, which is positioned with at least one free end so that it tapers or narrows the opening cross section of one of the longitudinal grooves.

The particular advantage of the described measure is that it avoids or at least reduces the folding noise of a classic wiper blade, which otherwise occurs at the reversal point between two wiping movements due to a loss of contact between a spring rail of the wiper blade and a rubber body held by the spring rail. In contrast, the invention's wiper strip has a damping element that tapers the longitudinal groove of the wiper strip, which is used for engagement by a spring rail, due to the positioning of its free end. This ensures that even when the wiper strip is folded down, reliable contact is maintained between the rubber body of the wiper strip and a spring rail that engages with it. If, despite these measures, the contact between the rubber body of the wiper strip and an engaging spring rail cannot be fully maintained, there is still a reduced gap between the rubber body of the wiper strip and an engaging spring rail at the reversal point, resulting in greatly reduced folding noises.

This is particularly due to the fact that a free end of the damping element, which tapers the longitudinal groove of the wiper strip, is bent to the side when a spring rail is inserted, so that the spring rail longitudinal groove of the wiper strip can be positioned so that it completely fills it, but at the same time the damping element remains in contact with the surface of the spring rail with a slight contact pressure due to its elasticity.

If the rubber body flips over between two wiping movements at the wiper strip's reversal point, causing a geometric distortion of the rubber profile, the longitudinal groove in the area of the wiper strip head may widen to such an extent that physical contact is lost between the rubber body and the spring rail. However, the damping element will remain in physical contact with the spring rail due to the contact pressure of the free end of the damping element on the spring rail. This has a favorable effect in terms of avoiding the noise of the rubber body of the wiper strip reversing between two wiping processes. This way, rattling noises can be greatly reduced or even completely avoided.

It is advantageous if the head part of the wiper strip is made of a different rubber material from that of the damping element. In particular, the rubber materials of the head part and the damping element differ in terms of their elastic behavior. It is particularly advantageous if the damping element is made of a porous rubber material, for example.

It is also advantageous if the damping element is made of the same rubber material as the tilt bar and the wiper wedge of the wiper strip. This is due to the fact that the head of a wiper strip is usually made of a comparatively hard rubber material, while the tilt bar and wiper wedge are made of a softer or more elastic rubber material. Such a more elastic rubber material also has favorable properties with regard to the noise-damping function of a damping element. A further advantage is that the previously used rubber types for the head part or for the tilt bar and the wiper wedge can continue to be used and the use of a third, additional rubber material is avoided.

Furthermore, it is possible to use the same type of rubber for the head part and the damping element of the wiper strip, but to use a rubber material of different Shore hardness for each of the same rubber type. For example, a rubber material with a higher Shore hardness is used for the head part and a rubber material with a lower Shore hardness is used for the damping element.

According to a further advantageous embodiment of the present invention, the wiper strip according to the invention comprises a further damping element, which is positioned between the wiper wedge and the head part and which, towards its free end, has an increasing distance to the head part of the wiper strip. At the reversal point of the wiper strip between two wiping movements, the wiper strip tilts in the area of the tilt bar, causing the damping element to potentially strike areas of the head part. Since this is a cushioned impact, this measure leads to a further reduction in the noise of the wiper strip being flipped over during operation.

According to a particularly advantageous embodiment of the present invention, the wiper strip according to the invention further comprises a further damping element, which, for example, is also positioned in the area of the longitudinal grooves of the wiper strip, like the first damping element, and which is also positioned with its free end such that it tapers or narrows the opening cross section of one of the longitudinal grooves. However, this further damping element is arranged in the area of the longitudinal groove such that it is arranged on a side-delimiting surface of the longitudinal groove that lies opposite a further side-delimiting surface on which the first damping element is arranged. This makes it easier to insert a spring rail into the longitudinal grooves of the wiper strip. It is possible for the free end of the additional damping element to narrow the longitudinal groove in the opposite direction to the course of the free end of the first damping element.

According to another particularly advantageous embodiment of the present invention, the damping element of the wiper strip is designed with a bent or flattened cross section in an area that comes into contact with a spring rail to be inserted or already inserted into the longitudinal groove.

Both measures have the effect that when the wiper blade is installed, the corresponding wiper strip can be easily fitted with spring rails, since the frictional resistance between the spring rail and the rubber material of the wiper strip is reduced.

The wiper strip according to the invention is used, for example, in wiper blades for vehicles, such as motor vehicles, rail or aircraft. Furthermore, the wiper strip or a wiper blade containing said wiper strip is suitable for cleaning stationary building glazing or for cleaning sensor surfaces, in particular the surfaces of optical sensors.

### BRIEF DESCRIPTION OF THE DRAWINGS

The drawings show embodiments of the present invention and are explained in more detail in the following description of the figures. Shown are:

FIGS. 1a, 1b shows the schematic cross section of a wiper blade according to the prior art

FIG. 2 shows the schematic cross section of a wiper strip according to a first embodiment of the present invention,

FIG. 3 shows the schematic cross section of a wiper blade according to an embodiment of the present invention,

FIGS. 4a to 4c, show the wiper blade shown in FIG. 3 during a wiping movement,

FIG. 5 shows the schematic cross section of a wiper strip according to a second embodiment of the present invention,

FIG. 6 shows the schematic cross section of a wiper strip according to a third embodiment of the present invention,

FIG. 7 shows the schematic cross section of a wiper strip according to a fourth embodiment of the present invention,

FIG. 8 shows the schematic cross section of a wiper strip according to a fifth embodiment of the present invention,

FIG. 9 shows the schematic cross section of a wiper strip according to a sixth embodiment of the present invention,

FIG. 10 shows the schematic cross section of a wiper strip according to a seventh embodiment of the present invention,

FIG. 11 shows the schematic cross section of a wiper strip according to an eighth embodiment of the present invention,

FIG. 12 shows the schematic cross section of a wiper strip according to a ninth embodiment of the present invention,

FIG. 13 shows the schematic cross section of a wiper strip according to a tenth embodiment of the present invention,

FIG. 14 shows the schematic cross section of a wiper strip according to an eleventh embodiment of the present invention,

FIG. 15 shows the schematic cross section of a wiper strip according to a twelfth embodiment of the present invention,

FIG. 16 shows the schematic cross section of a wiper strip according to a thirteenth embodiment of the present invention,

FIG. 17 shows the schematic cross section of a wiper strip according to a fourteenth embodiment of the present invention

FIG. 18 shows the schematic cross section of a wiper strip according to a fifteenth embodiment of the present invention,

FIG. 19 shows the schematic cross section of a wiper strip according to a sixteenth embodiment of the present invention; and

FIG. 20 shows the schematic cross section of a wiper strip according to a seventeenth embodiment of the present invention.

### DETAILED DESCRIPTION

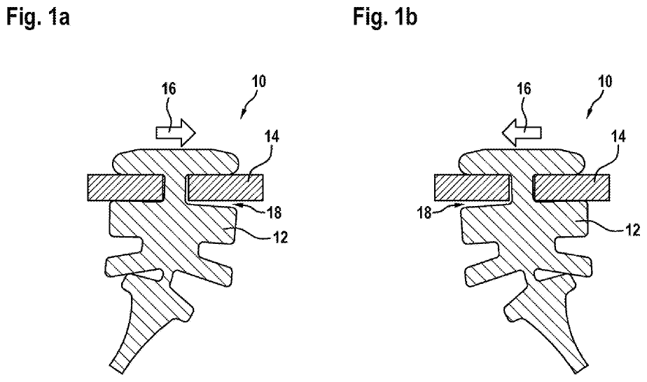

FIGS. 1a and 1b show a wiper blade according to the prior art during a wiping movement. The wiper blade 10 comprises a rubber body 12 and spring rails 14 that engage in it. When the wiper blade 10 is guided over a surface to be cleaned in a direction of movement illustrated by the arrows 16, the rubber body 12 is detached from the surface of the spring rail 14 in the areas 18. When the direction of movement changes, the opposite deformation of the rubber body 12 causes a snapping sound, which can essentially be attributed to the rubber body 12 striking the surface of the spring rail 14.

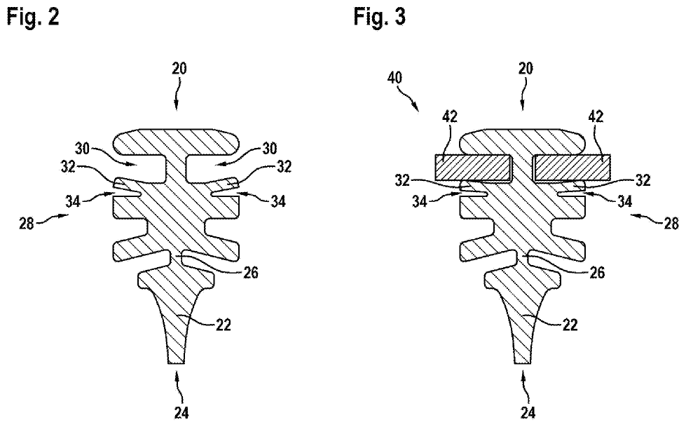

FIG. 2 shows a wiper strip according to a first embodiment of the present invention. The wiper strip 20 comprises a wiper wedge 22, which forms a wiper lip 24 at its end. The wiper wedge 22 is connected to a head part 28 of the wiper strip 20 by means of a tilt bar 26. The head part 28 is made, for example, of a harder rubber material than the tilt bar 26 or the wiper wedge 22. Furthermore, the head part 28 comprises two longitudinal grooves 30 made on opposite sides of the head part 28. These serve for the engagement of a carrying element, for example in the form of metallic spring rails, which serve to fasten the wiper strip 20 to a wiper arm.

In addition, the head part 28 comprises additional first damping elements 32, which are formed on opposite sides of the head part 28 in the area of the longitudinal grooves 30. In this case, the first damping elements 32 have, for example, a strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their terminal free part or end facing away from the head part 28.

Furthermore, the first damping elements 32 are designed on the head part 28 such that gaps 34 are formed between them and the material of the head part 28, facing away from the longitudinal grooves 30, wherein the width of the gaps 34 increases or widens in the direction of the free ends of the first damping elements 32.

The first damping elements 32, for example, are made of a soft or highly elastic rubber material. This may, for example, be the same rubber material as that used for the tilt bar 26 or the wiper wedge 22 of the wiper strip 20. However, it is also possible to use a porous or foam-like rubber material for the first damping elements 32. Furthermore, it is possible that the first damping elements 32 are made of the same type of rubber as the head part 28, but of a rubber material with a lower Shore hardness compared to the rubber material of the head part 28. The first damping elements 32 and the head part 28 of the wiper strip 20 can be produced, for example, by means of coextrusion.

FIG. 3 schematically illustrates a wiper blade 40 comprising a wiper strip 20 according to FIG. 1. The same reference numerals indicate the same components as in FIG. 2.

In addition to the wiper strip 20, the wiper blade 40 also comprises spring rails 42, which serve as a supporting element for the wiper strip 20 and which are inserted into the longitudinal grooves 30 of the wiper strip 20 on both sides. As can be seen schematically in FIG. 3, the insertion of the spring rails 42 leads to a widening of the longitudinal groove 30 in the areas narrowed by the presence of the first damping elements 32.

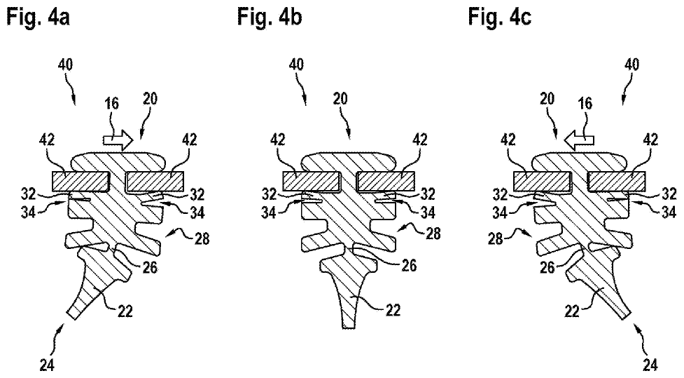

FIGS. 4a to 4c schematically show the behavior of wiper blade 40 during different stages of a wiping process over a surface to be cleaned. The same reference numerals continue to denote the same component parts as in the preceding figures.

FIGS. 4a to 4c in particular illustrate the deformations of the wiper strip 20 that occur when the wiper blade 40 reverses direction of movement during operation. FIG. 4a shows the wiper blade 40 during an initial direction of movement, as indicated by the arrow 16, direction of movement, in FIG. 4b during a standstill at the reversal point and in FIG. 4c a wiper blade 40 during a counter-rotational movement of the wiper blade 40 after the reversal point, which is also illustrated by an arrow 16. In none of the stages of movement illustrated in FIGS. 4a to 4c does the wiper strip 20 come loose from the spring rails 42, but rather the spring rails 42 are always bounded and guided on both sides by components of the head part 28 of the wiper strip 20 during the entire process.

Furthermore, as illustrated in FIGS. 4a and 4c, the shear forces acting on the wiper strip 20 are partially absorbed by narrowing the gaps 34, and the damping effect of the first damping elements 32 prevents noise. By closing the gap 34, the wiper strip 20 is thus supported on the spring rail 42. This leads to a significant reduction in noise in this area.

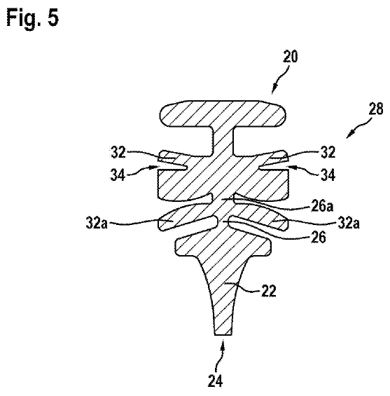

In FIG. 5, a wiper strip according to a second embodiment of the present invention is schematically shown.

The wiper strip 20 shown in FIG. 5 comprises, in addition to the first damping elements 32, further damping elements 32a, which are provided in the area of the tilt bar 26. For this reason, the wiper strip 20 comprises a first tilt bar 26 and a second tilt bar 26a, wherein the further damping elements 32a are positioned between the two tilt bars 26, 26a. The further damping elements 32a have a comparable structure to the first damping elements 32 and are, for example, designed in the form of strips and are anchored, for example, on the end face to the wiper strip 20.

As already described, the rubber body of wiper strip 20 tilts during a wiping process. The further damping elements 32a now ensure that when the wiper wedge 22 tilts against the head part 28, the impact of parts of the wiper wedge 22 on the large surface of the head part 28 facing it, but—due to the further damping elements 32a arranged in between—to a damped impact and thus to the suppression of flipping-over noises. The other damping elements 32a can, for example, be made of the same rubber material as the first damping elements 32.

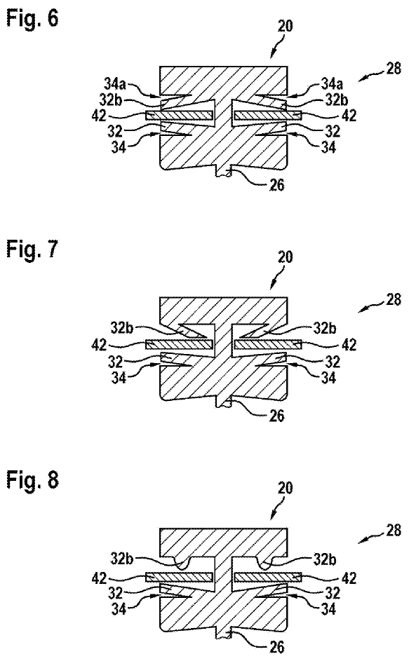

In FIG. 6, a wiper strip according to a third embodiment of the present invention is schematically shown.

The wiper strip 20 shown in FIG. 6 comprises, in addition to the first damping elements 32, further damping elements 32b, which are arranged horizontally in a mirror-inverted manner and are also provided in the area of the head part 28 in the longitudinal groove 30. The further dampening elements 32b, for example, like the first dampening elements 32, have a strip-shaped design and are, for example, also formed on the head part 28 with one of their longitudinal surfaces.

The further dampening elements 32b are arranged in the area of the longitudinal grooves 30 such that they are arranged on a side-delimiting surface of the longitudinal groove 30 that lies opposite to a further side-delimiting surface on which the first dampening elements 32 are arranged. This makes it easier to insert a spring rail 42 into the longitudinal grooves 30 of the wiper strip 20. Furthermore, the further damping elements 32b are positioned with respect to the head part 28 such that they reduce or narrow or taper the clear cross section of the longitudinal grooves 30 with their terminal free part facing away from the head part 28.

Furthermore, the first further elements 32b are also designed on the head part 28 such that further gaps 34a are formed between them and the material of the head part 28, facing away from the longitudinal grooves 30, wherein the width of the further gaps 34a increases or widens in the direction of the free ends of the further damping elements 32b.

The further damping elements 32a are made of a comparable rubber material as the first damping elements 32.

This further reduces possible flapping noises of the wiper blade at the reversal point between two wiping movements and at the same time allows simplified insertion of the spring rails 14 into the longitudinal grooves 30 of the head part 28.

In FIG. 7, a wiper strip according to a fourth embodiment of the present invention is schematically shown.

The wiper strip 20 shown in FIG. 7 also comprises, in addition to the first damping elements 32, further damping elements 32b, which are arranged horizontally in a mirror-inverted manner and are also provided in the area of the head part 28 in the longitudinal groove 30. The further dampening elements 32b, for example, like the first dampening elements 32, have a strip-shaped design and are, for example, also formed on the head part 28 with one of their longitudinal surfaces. Furthermore, the further damping elements 32b are positioned with respect to the head part 28 such that they reduce or narrow or taper the clear cross section of the longitudinal grooves 30 with their terminal free part facing away from the head part 28. In contrast to the embodiment shown in FIG. 6, the further damping elements 32b are arranged in the opposite direction compared to the further damping elements 32b according to FIG. 6, or rather face the central area of the head part 28 with their free part.

The first further elements 32b are also designed on the head part 28 such that further gaps 34a are formed between them and the material of the head part 28, facing the base of longitudinal grooves 30, wherein the width of the further gaps 34a increases or widens in the direction of the free ends of the further damping elements 32b.

In FIG. 8, a wiper strip according to a fifth embodiment of the present invention is schematically shown.

The wiper strip 20 shown in FIG. 8 also comprises, in addition to the first damping elements 32, further dampening elements 32b which are arranged in the area of the longitudinal grooves 30 such that they are arranged on a side-delimiting surface of the longitudinal groove 30 that lies opposite to a further side-delimiting surface on which the first dampening elements 32 are arranged. The other damping elements 32b, for example, are designed as elevations that tapers the cross section of the longitudinal groove. This also makes it easier to insert a spring rail 42 into the longitudinal grooves 30 of the wiper strip 20.

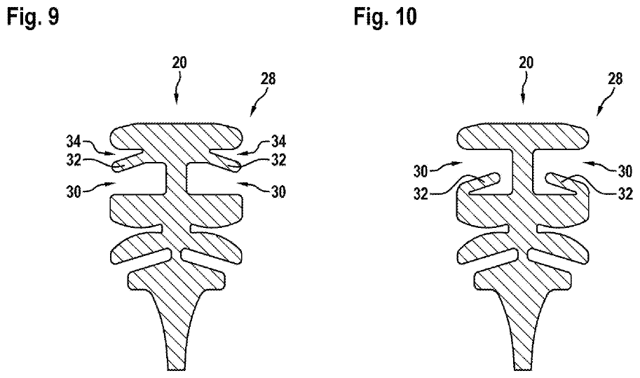

In FIG. 9, a wiper strip according to a sixth embodiment of the present invention is schematically shown.

As in the first embodiment shown in FIG. 2, the head part 28 of the wiper strip 20 comprises first damping elements 32, which are formed on opposite sides of the head part 28 in the area of the longitudinal grooves 30, but on opposite side-delimiting surfaces of the longitudinal grooves 30 compared to the embodiment according to FIG. 2. In this case, the first damping elements 32 also have, for example, a strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their terminal free part facing away from the head part 28.

Furthermore, the first damping elements 32 are also designed on the head part 28 such that gaps 34 are formed between them and the material of the head part 28, facing away from the longitudinal grooves 30, wherein the width of the gaps 34 increases or widens in the direction of the free ends of the first damping elements 32.

In FIG. 10, a wiper strip according to a seventh embodiment of the present invention is schematically shown.

As in the first embodiment shown in FIG. 2, the head part 28 of the wiper strip 20 also comprises additional first damping elements 32, which are formed on opposite sides of the head part 28 in the area of the longitudinal grooves 30. In this case, the first damping elements 32 also have, for example, a strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their terminal free part facing away from the head part 28. However, this is done in the opposite way to the embodiment according to FIG. 2, in that the free parts or ends of the first damping elements 32 are oriented towards the center of the wiper strip.

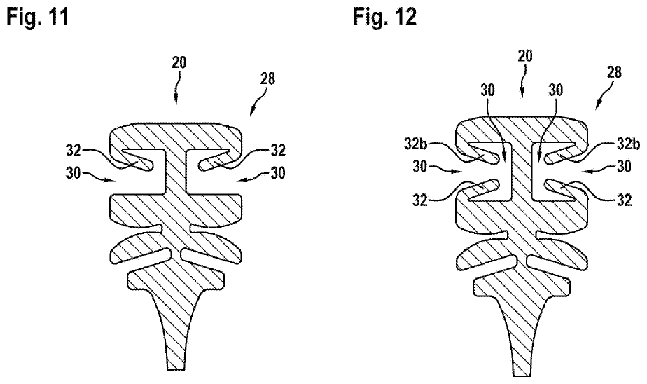

In FIG. 11, a wiper strip according to an eighth embodiment of the present invention is schematically shown.

As in the sixth embodiment shown in FIG. 9, the head part 28 of the wiper strip 20 comprises first damping elements 32, which are formed on opposite sides of the head part 28 in the area of the longitudinal grooves 30 on side-delimiting surfaces of the longitudinal grooves 30 according to FIG. 9. Furthermore, the first damping elements 32 are oriented with their free parts towards the center of the wiper strip 20, analogous to the seventh embodiment shown in FIG. 10.

In FIG. 12, a wiper strip according to a ninth embodiment of the present invention is schematically shown.

The head part 28 of the wiper strip 20 comprises the first damping elements 32, 32b, which, in the combination of the embodiments seven and eight, are arranged on opposite sides of the head part 28 in the area of the longitudinal grooves 30 and on both sides on opposite side-delimiting surfaces of the longitudinal grooves 30 and are oriented with their free parts towards the center of the wiper strip 20.

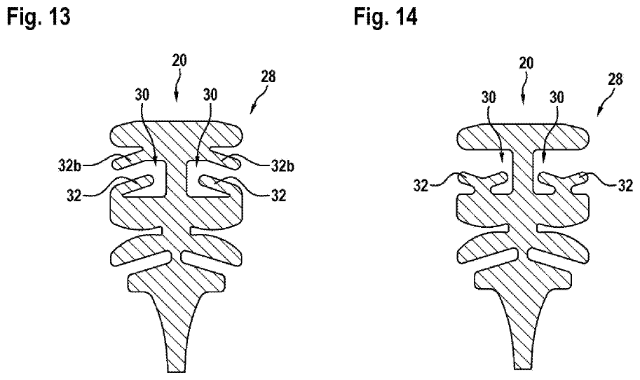

In FIG. 13, a wiper strip according to a tenth embodiment of the present invention is schematically shown.

The head part 28 of the wiper strip 20 comprises the first damping elements 32, 32b, which, in the combination of the embodiments six and seven, are arranged on opposite sides of the head part 28 in the area of the longitudinal grooves 30 and on both sides on opposite side-delimiting surfaces of the longitudinal grooves 30.

In FIG. 14, a wiper strip according to an eleventh embodiment of the present invention is schematically shown.

As in the first embodiment shown in FIG. 2, the head part 28 of the wiper strip 20 comprises first damping elements 32, which are formed on opposite sides of the head part 28 in the area of the longitudinal grooves 30. In this case, the first damping elements 32 have, for example, a dual strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their two terminal free parts or ends facing away from the head part 28.

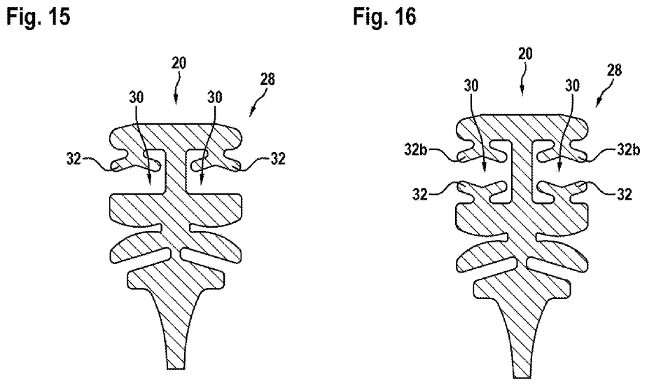

In FIG. 15, a wiper strip according to a twelfth embodiment of the present invention is schematically shown.

As in the eleventh embodiment shown in FIG. 14, the head part 28 of the wiper strip 20 comprises first damping elements 32, which are formed on opposite sides of the head part 28 in the area of the longitudinal grooves 30, but on opposite side-delimiting surfaces of the longitudinal grooves 30 compared to the embodiment according to FIG. 14. In this case, the first damping elements 32 also have, for example, a dual strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their two terminal free parts or ends facing away from the head part 28.

In FIG. 16, a wiper strip according to a thirteenth embodiment of the present invention is schematically shown.

The head part 28 of the wiper strip 20 comprises the first damping elements 32, 32b, which, in the combination of the embodiments eleven and twelve, are arranged on opposite sides of the head part 28 in the area of the longitudinal grooves 30 and on both sides on opposite side-delimiting surfaces of the longitudinal grooves 30.

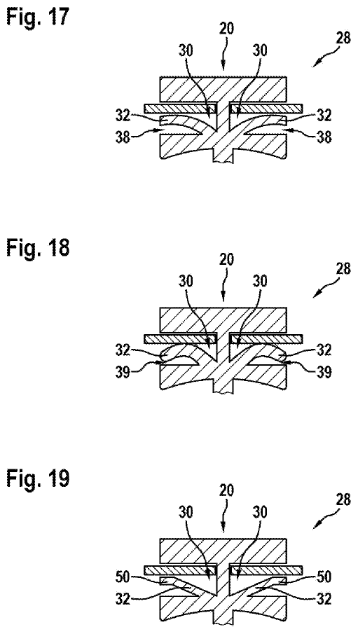

In FIG. 17, a wiper strip according to a fourteenth embodiment of the present invention is schematically shown.

As in the first embodiment shown in FIG. 2, the head part 28 of the wiper strip 20 comprises first damping elements 32, which are formed on opposite sides of the head part 28 in the area of the longitudinal grooves 30. In this case, the first damping elements 32 also have, for example, a strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their terminal free part facing away from the head part 28. The first damping elements 32 are designed such that, in those areas which come into surface contact with the spring strip 42 when a spring strip 42 is inserted into the longitudinal grooves 30 of the wiper strip 20, they have a flattened area 38 facing the spring strip, which preferably lies flat against the surface of a spring rail 42 to be inserted or already inserted. This embodiment ensures particularly effective suppression of switching noises from wiper strip 20 during subsequent operation.

FIG. 18 schematically shows a wiper strip according to a fifteenth embodiment of the present invention.

As in the fourteenth embodiment shown in FIG. 17, the head part 28 of the wiper strip 20 comprises first damping elements 32, which are formed on opposite sides of the head part 28 in the area of the longitudinal grooves 30. In this case, the first damping elements 32 also have, for example, a strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their terminal free part facing away from the head part 28. The first damping elements 32 are designed such that, in those areas which come into surface contact with the spring strip 42 when a spring strip 42 is inserted into the longitudinal grooves 30 of the wiper strip 20, they have a bent area 39 facing the spring strip, which preferably lies flat against the surface of a spring rail 42 to be inserted or already inserted. This embodiment also ensures particularly effective suppression of switching noises from wiper strip 20 during subsequent operation.

In FIG. 19, a wiper strip according to a sixteenth embodiment of the present invention is schematically shown.

As in the first embodiment shown in FIG. 2, the head part 28 of the wiper strip 20 comprises first damping elements 32, which are formed on opposite sides of the head part 28 in the area of the longitudinal grooves 30. In this case, the first damping elements 32 also have, for example, a strip-shaped design and are, for example, formed on the head part 28 with one of their longitudinal surfaces. Furthermore, the first damping elements 32 are positioned with respect to the head part 28 such that they reduce or narrow or taper the clear cross section of the longitudinal grooves 30 with their terminal free part facing away from the head part 28. The first damping elements 32 are designed such that their free parts or ends have a beveled profile 50 which, when a spring strip 42 is inserted into the longitudinal grooves 30 of the wiper strip 20, comes into surface contact with the spring strip 42 and preferably lies flat against the surface of a spring rail 42 to be inserted or already inserted. This embodiment also ensures particularly effective suppression of switching noises from wiper strip 20 during subsequent operation.

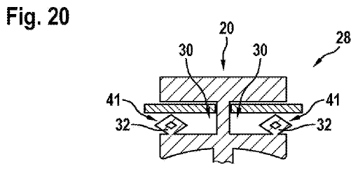

In FIG. 20, a wiper strip according to a seventeenth embodiment of the present invention is schematically shown.

As in the first embodiment shown in FIG. 2, the head part 28 of the wiper strip 20 comprises first damping elements 32, which are formed on opposite sides of the head part 28 in the area of the longitudinal grooves 30. The first damping elements 32, for example, are designed as hollow profiles 41 with a diamond-shaped cross section, for example, and are molded onto the head part 28 in the area of a longitudinal edge, for example. Furthermore, the first damping elements 32 are positioned with respect to the head part 28 such that they reduce or narrow or taper the clear cross section of the longitudinal grooves 30 with their terminal longitudinal edge facing away from the head part 28.

1. A wiper strip comprising a wiper wedge (22) on which a wiper lip (24) is formed, and comprising a head part (28) which is connected by a tilt bar (26) to the wiper wedge (22) and which has a longitudinal groove (30) on each of two opposite sides of the head part (28) for engagement of a spring rail (42) into the head part (28) of the wiper strip (20), wherein the head part (28) furthermore has at least one damping element (32, 32b), at least a free end of which tapers a cross section of one of the longitudinal grooves (30).

2. The wiper strip according to claim 1, wherein a damping element (32, 32b) is provided on both sides of the head part (28) of the wiper strip (20).

3. The wiper strip according to claim 1, wherein the at least one damping element (32, 32b) tapers the cross section of one of the longitudinal grooves (30) with its free end, forming a gap (34a) between the head part (28) and a large surface of the free end of the damping element (32, 32b) facing away from the respective longitudinal groove (30).

4. The wiper strip according to claim 1, wherein at least one first damping element (32, 32b) is positioned on a first side-delimiting surface of the longitudinal groove (30) and tapers the cross section of the longitudinal groove (30) with its free end, and furthermore at least one further damping element (32b) is provided, which is positioned on a second side-delimiting surface lying opposite the first side-delimiting surface, of the longitudinal groove (30), which tapers the cross section of the longitudinal groove (30) with its free end.

5. The wiper strip according to claim 4, wherein the free end of the further damping element (32b) tapers the cross section of the longitudinal groove (30) in an opposite direction to the free end of the first damping element (32).

6. The wiper strip according to claim 1, wherein the at least one damping element (32, 32b) has a bent or flattened cross section (38, 39) in an area that comes into contact with a spring rail (42) to be inserted into the longitudinal groove (30).

7. The wiper strip according to claim 1, wherein a further damping element (32a) is arranged between the wiper wedge (22) and the head part (28), wherein a distance between the further damping element (32a) and the head part (28) increases in a direction of a free end of the further damping element (32a).

8. The wiper strip according to claim 1, wherein the head part (28) and the at least one damping element (32, 32a, 32b) have different types of rubber with different elastic behavior.

9. The wiper strip according to claim 1, wherein the at least one damping element (32, 32a, 32b) is made, at least in some areas, of a porous rubber material.

10. The wiper strip according to claim 1, wherein the at least one damping element (32, 32a, 32b) is made of a same rubber material as the wiper wedge (22), the wiper lip (24) and/or the tilt bar (26) of the wiper strip (20).

11. The wiper strip according to claim 1, wherein the at least one damping element (32, 32a, 32b) is made of a same type of rubber, but with a different Shore hardness compared to the head part (28) of the wiper strip (20).

12. A wiper blade, comprising a wiper strip according to claim 1.

13. A wiper blade according to claim 12 for cleaning vehicle windshields or stationary building glazing or sensor surfaces.
